(19) United States
(12) Patent Application Publication
(10) Pub. No.: US 2026/0307588 A1
(43) Pub. Date: Oct. 8, 2026

(54) METHOD AND APPARATUS FOR DISPLAYING MANOEUVRE-RELATED ASSISTIVE LINES IN A DISPLAY OF A VEHICLE

(71) Applicant: Robert Bosch GmbH, Stuttgart (DE)

(72) Inventors: Maxe Hinkelmann, Fronhausen (DE); Andreas Panakos, Stuttgart (DE); Jose Domingo Esparza Garcia, Stuttgart (DE)

(21) Appl. No.: 19/491,461

(22) PCT Filed: Jun. 12, 2024
(86) PCT No.: PCT/EP2024/066194

§ 371 Date: Feb. 3, 2026

(30) Foreign Application Priority Data
Jun. 19, 2023 (DE) 10 2023 205 719.0

(51) Int. Cl. B60R 1/26; B60K 35/22; B60K 35/23; G06T 11/00; G06V 20/58

(52) U.S. Cl. CPC B60R 1/26; G06T 11/00; G06V 20/58; B60K 35/22; B60K 35/23; B60R 2300/205; B60R 2300/308; B60R 2300/8093

(57) ABSTRACT

A method and an apparatus for displaying maneuver-related assistive lines in a display of a vehicle. The method includes: a first step to produce a camera image using a camera arranged on the vehicle, the camera image capturing both an environment of the vehicle and a collision-related part of the vehicle; a second step to ascertain an outer contour of the collision-related part of the vehicle; and a third step to display the camera image in the display of the vehicle, the camera image being overlaid with at least one assistive line, provided for a maneuvering operation, that extends from the outer contour of the collision-related part of the vehicle into the environment of the vehicle.

### FIELD

The present disclosure relates to a method and an apparatus for displaying maneuver-related assistive lines in a display of a vehicle.

### BACKGROUND INFORMATION

The related art describes certain camera systems for vehicles, on the basis of which two-dimensional images of an environment of the vehicles are captured in order to display these in a display of the vehicles for a better overview of the environment.

By way of example, use is made of cameras with fisheye lenses, the raw images from which are suitably corrected prior to being displayed in a display of the vehicles.

Visible parts of the real vehicle (also called “vehicle inclusions”), such as bumpers, etc., are often visible in the raw images from the cameras, so that a driver of such a vehicle can better estimate the distance between their own vehicle and objects in the environment of the vehicle on the basis of the camera images.

Current vehicle systems additionally overlay assistive lines, such as trajectories of the wheels, onto the camera image in order to assist with vehicle maneuvers such as parking, reversing, etc.

Germany Patent Application No. DE 10 2007 011 180 describes a maneuvering assistant for a vehicle or for a vehicle train having articulated vehicle elements, wherein the maneuvering assistant is designed on the basis of a camera to capture rearward surroundings of the vehicle in order to determine by way of image data produced by the camera whether the vehicle can be straightened starting from a current position within a specifiable length of path. For this purpose, the future course of travel of the vehicle its predicted driving track and/or its towing track and is symbolically superimposed in correct perspective over the image data captured by the camera.

Subsequently, the image data thus processed are displayed to the driver of the vehicle for aiding in the maneuver.

United States Patent Application Publication No. US 2020/0346690A1 describes a parking assistance device, which in one specific embodiment is designed to display a camera image on a display of a vehicle, which has assistive lines superimposed on it in order to support a driving maneuver.

### SUMMARY

According to a first aspect of the present disclosure, a method for displaying maneuver-related assistive lines in a display of a vehicle is proposed, the vehicle being, for example, a road vehicle (e.g., motorcycle, car, van, truck) or a rail vehicle or an aircraft/airplane and/or a watercraft.

In a first step of the method according to an example embodiment of the present disclosure, a camera image is produced by means of a camera arranged on the vehicle, the camera image capturing both an environment (in particular a collision-related environment) of the vehicle and a collision-related part of the vehicle. The expression “collision-related part of the vehicle” is to be understood to mean a constituent part of the body of the vehicle and/or an add-on part of the vehicle which, during a driving maneuver in the direction of the field of view of the camera, is highly likely to be the first to come into contact with objects foreign to the vehicle (e.g., other vehicles, obstacles, etc.) if the driving maneuver is executed incorrectly and/or the object foreign to the vehicle is not seen, or not reliably seen, by the driver of the vehicle.

Preferably, at least one such detail from the environment of the vehicle is captured that is relevant to a current driving maneuver. Accordingly, it is possible for the method according to the present disclosure to be applied in conjunction with a plurality of differently positioned and/or oriented cameras of the vehicle individually or simultaneously, in order to use in each case the camera(s), and the camera images therefrom, most suitable for a current driving maneuver.

In a second step of the method according to an example embodiment of the present disclosure, an outer contour of the collision-related part of the vehicle is ascertained. The ascertainment is performed, for example, by an evaluation unit of the vehicle. The outer contour of the collision-related part, which is a portion of an outer contour of the vehicle, thus represents the line at which the part of the body of the vehicle that is visible in the camera image adjoins the part of the camera image that represents the environment of the vehicle.

In a third step of the method according to the present disclosure, the camera image is displayed in the display of the vehicle, which is preferably arranged in an interior of the vehicle, the camera image being overlaid with at least one assistive line, provided for a maneuvering operation, which extends from the outer contour of the collision-related part of the vehicle into the environment of the vehicle. In principle, no restriction is placed on the way in which the assistive line is expressed in terms of shape and/or arrangement and/or extent and/or color and/or texture and/or length, etc.

The assistive line or a plurality of assistive lines are produced, for example by means of the above-described evaluation unit, and are combined with the camera image. By connecting the display to the evaluation unit via information technology, the camera image with the overlaid assistive lines can be displayed in the display by the evaluation unit.

Since, according to the present disclosure, the at least one assistive line extends to the outer contour of the collision-related part of the vehicle and accordingly is adapted to the course of the outer contour and moreover does not project into the collision-related part of the vehicle, a user, in particular a driver of the vehicle, is given the impression that the at least one assistive line continues beneath the vehicle. This improves the relationship between the assistive line and the vehicle when viewing the display content, as a result of which driving maneuvers (e.g., parking) can be carried out more easily and/or more precisely, as a result of which, inter alia, collisions can be better avoided when carrying out such driving maneuvers.

Preferred developments and example embodiment are disclosed herein.

In one advantageous example embodiment of the present disclosure, the at least one assistive line is sharply cropped by the outer contour of the collision-related part of the vehicle.

In one particularly advantageous embodiment of the present disclosure, at least one optical property of the at least one assistive line is gradually varied in the direction of the outer contour in a region starting from the environment and directly adjoining the outer contour. Based on this gradual variation, it is possible, for example, to enhance the impression given to the user that the assistive line continues beneath the vehicle. In addition, any tolerances at the transition between the assistive line and the outer contour can be concealed by means of the gradual variation. The optical property of the at least one assistive line preferably represents a transparency and/or a brightness and/or a color and/or a texture of the assistive line. With particular advantage, the transparency of the assistive line is increased in the direction of the outer contour and/or the brightness of the assistive line is reduced in the direction of the outer contour. As a result, the assistive line within the predefined region is “faded out” in the direction of the outer contour, so that, inter alia, the advantages described above can be achieved particularly effectively. Furthermore, by suitably defining the extent and/or shape of the predefined region, the impression can be achieved that the assistive line is shadowed by the vehicle body as it approaches the outer contour of the vehicle, for example by gradually darkening the assistive line.

In another advantageous example embodiment of the present disclosure, the region adjoining the outer contour is a predefined region and/or a region which is adapted to current boundary conditions. As an alternative or in addition, it is possible that the at least one optical property of the assistive line is additionally adapted according to the current boundary conditions. Such boundary conditions include, in particular, current lighting conditions and/or a current shadow cast by the vehicle and/or a shadow cast by a component mechanically connected to the vehicle (e.g., a trailer, a trailer hitch, a bicycle carrier). In other words, by taking such boundary conditions into account, a particularly realistic representation of the at least one assistive line can be achieved by defining the gradual variation thereof, which is intended to depict, for example, a shadow cast by the vehicle, according to the position of the sun relative to the vehicle.

With particular preference, the at least one assistive line represents a trajectory and/or a boundary line of a driving lane for the vehicle. In the latter case, the assistive line is preferably a first assistive line, while the display is overlaid with a second assistive line that is produced analogously to the first assistive line. Thus, the first and the second assistive line form respective lateral boundaries of the driving lane in which the vehicle preferably moves during a driving maneuver.

Advantageously, the outer contour of the collision-related part of the vehicle is ascertained on the basis of a predefined geometric model (e.g., a 2D model and/or a 3D model) of the vehicle and/or on the basis of an image recognition method using the camera image. The latter offers the advantage that any outer contour-related modifications made to the vehicle (e.g., mounting a bicycle carrier in the region of a rear camera of the vehicle, etc.) are taken into account automatically, so that the at least one assistive line always adjoins the modified outer contour, regardless of such a modification. This ascertainment is preferably performed repeatedly (e.g., every time the vehicle is started and/or while driving) on the basis of the image recognition method in order to be able to take into account modifications to the vehicle in a timely manner. Ascertainment on the basis of the image recognition method may also prove advantageous, for example, in a situation where an orientation and/or arrangement position of the camera on the vehicle changes unintentionally. In this case, too, it can be ensured that the assistive line is always adapted to the outer contour of the vehicle.

In another advantageous example embodiment of the present disclosure, the camera is a reversing camera, a front camera, or a side camera of the vehicle. As an alternative or in addition, the collision-related part of the vehicle represents at least a part of a bumper and/or a trailer hitch of the vehicle.

Furthermore, the outer contour and/or the collision-related part of the vehicle is advantageously at least partially overlaid with a corresponding assistive graphic in the display. This can advantageously be used to enhance a contrast between the environment and the outer contour and/or other regions of the collision-related part and/or to highlight the transition between the vehicle and the environment in a way that is generally more clear. To this end, the line of the outer contour may be colored, for example, in a signal color (e.g., red, orange, etc.).

The display of the vehicle is, for example, a central display and/or a display of an instrument cluster and/or a head-up display and/or a different display of the vehicle. Preferably, the display is arranged and oriented in such a way that it is easily visible, particularly to a driver of the vehicle, during a driving maneuver.

According to a second aspect of the present disclosure, an apparatus comprising an evaluation unit, a camera and a display is provided, wherein the evaluation unit is configured to execute a method according to the first aspect of the present disclosure on the basis of the camera and the display. The evaluation unit is designed, for example, as an ASIC, FPGA, processor, digital signal processor, microcontroller, or the like. The features, combinations of features and the advantages resulting therefrom correspond to those discussed in connection with the first-mentioned aspect of the present disclosure, such that reference is made to the above statements in order to avoid repetitions.

### BRIEF DESCRIPTION OF THE DRAWINGS

Exemplary embodiments of the present disclosure are described in detail below with reference to the figures.

FIG. 1 shows a schematic view of an example embodiment of an apparatus according to the present disclosure.

FIG. 2 shows an example of a camera image to be displayed in a display of a vehicle, said camera image having been produced by means of a method according to an example embodiment of the present disclosure.

### DETAILED DESCRIPTION OF EXAMPLE EMBODIMENTS

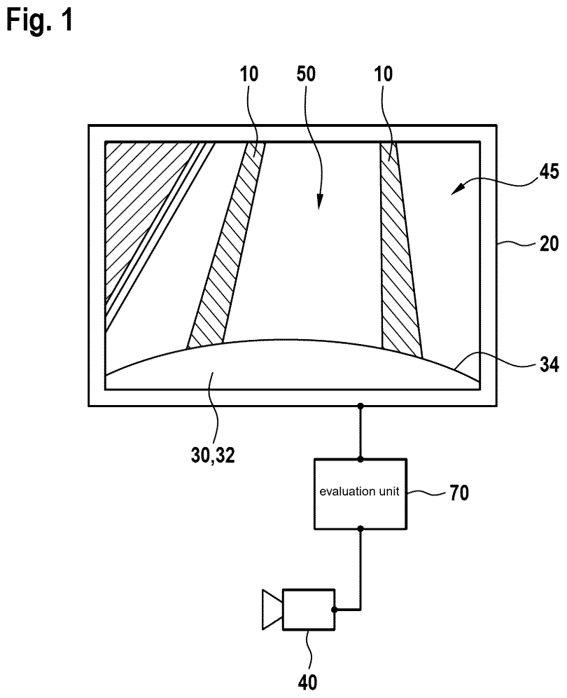

FIG. 1 shows a schematic view of an embodiment of an apparatus according to the present disclosure, comprising a camera 40, an evaluation unit 70, and a display 20 of a vehicle 30.

The camera 40 is designed here as a 2D RGB reversing camera, the evaluation unit 70 is designed here as a CPU, and the display 20 is designed here as a central display which is intended to be arranged in a center console of the vehicle 30.

The camera 40, which is intended to be mounted at the rear of the vehicle 30 for carrying out reversing maneuvers, is configured to produce a camera image 45 capturing both an environment 50 of the vehicle 30 and a collision-related part 32 of the vehicle 30.

The evaluation unit 70, which is connected to the camera 40 and the display 20 via information technology, is configured to receive the camera image 45 from the camera 40 and to ascertain the outer contour 34 of the collision-related part 32 of the vehicle 30 within the camera image 45 on the basis of an image recognition method.

The evaluation unit 70 is further configured to display the camera image 45 in the display 20, wherein a trajectory for respective left wheels and right wheels of the vehicle 30 is overlaid in the form of a left and a right assistive line 10 on the camera image 45 by the evaluation unit 70 for a reversing maneuver. The assistive lines 10 extend directly from the outer contour 34 of the collision-related part 32 of the vehicle 30 into the environment 50 of the vehicle 30. That is, the assistive lines 10 are sharply cropped by the outer contour 34 such that they exactly follow the course of the outer contour 34 at respective cropped edges. In other words, the evaluation unit 70 is configured to use the ascertained outer contour 34 as a mask to adapt the course of the assistive lines 10 to the outer contour 34.

This achieves the advantageous effect according to the present disclosure that the assistive lines 10 are continued beneath the vehicle 30, so that an improved relationship between the assistive lines 10 and the vehicle 30 is established.

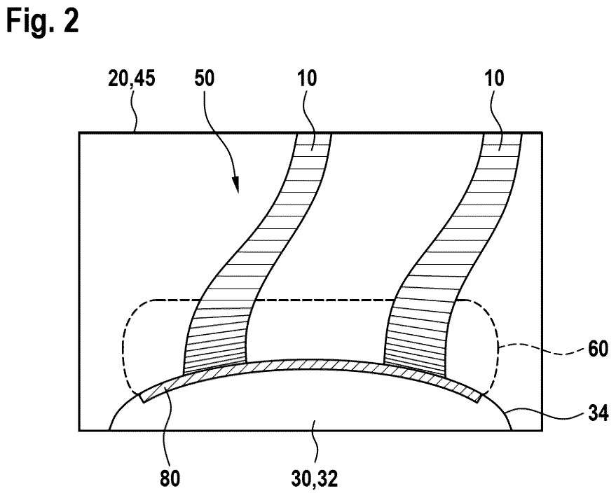

FIG. 2 shows an example of camera image 45 to be displayed in a display 20 of a vehicle 30, said camera image having been produced by means of a method according to the present disclosure.

Shown in the camera image 45 is a collision-related part 32 of the vehicle 30, for which an outer contour 34 has been ascertained by means of the method according to the present disclosure, said outer contour being overlaid here with an assistive graphic 80 which shows the outer contour 34 with a predefined width and colored red, in order to make the outer contour 34 particularly easily distinguishable from an environment 50.

According to the present disclosure, two assistive lines 10 are extended as far as the outer contour 34 of the vehicle 30, wherein the assistive lines 10 within a predefined region 60 adjoining the outer contour 34 are shown with decreasing brightness in the direction of the outer contour 34 relative to the portions of the assistive lines 10 outside the region 60.

This additionally enhances the impression of assistive lines 10 continuing beneath the vehicle 30.

1-10. (canceled)

11. A method for displaying maneuver-related assistive lines in a display of a vehicle, the method comprising the following steps:
producing a camera image using a camera arranged on the vehicle, wherein:
the camera image captures both an environment of the vehicle and a collision-related part of the vehicle, and
the collision-related part of the vehicle is a constituent part of a body of the vehicle and/or an add-on part of the vehicle, which, during a driving maneuver in a direction of a field of view of the camera, is highly likely to be first to come into contact with objects foreign to the vehicle;
ascertaining an outer contour of the collision-related part of the vehicle, wherein the outer contour of the collision-related part of the vehicle is:
a line at which the collision-related part of the body of the vehicle that is visible in the camera image adjoins a part of the camera image that represents the environment of the vehicle,
ascertained based on a predefined geometric model of the vehicle and/or based on an image recognition method using the camera image; and
displaying the camera image in the display of the vehicle, wherein the camera image is overlaid with at least one assistive line, provided for a maneuvering operation, which extends from the outer contour of the collision-related part of the vehicle into the environment of the vehicle, wherein:
the at least one assistive line is sharply cropped by the outer contour of the collision-related part such that the at least one assistive line exactly follows a course of the outer contour at a cropped edge, and
a transparency of the at least one assistive line is increased in a direction of the outer contour and/or a brightness of the at least one assistive line is reduced in a direction of the outer contour.

12. The method according to claim 11, wherein:
at least one optical property of the at least one assistive line is gradually varied in the direction of the outer contour in a region starting from the environment and directly adjoining the outer contour, and/or
the at least one optical property of the at least one assistive line represents a transparency and/or a brightness and/or a color and/or a texture of the at least one assistive line.

13. The method according to claim 12, wherein:
a region adjoining the outer contour is a predefined region and/or a region which is adapted to current boundary conditions, and/or
the at least one optical property of the at least one assistive line is additionally adapted according to the current boundary conditions, and/or
the current boundary conditions represent current lighting conditions and/or a shadow cast by the vehicle and/or a shadow cast by a component mechanically connected to the vehicle.

14. The method according to claim 11, wherein the at least one assistive line represents:
a trajectory for the vehicle, and/or
a boundary line of a driving lane for the vehicle.

15. The method according to claim 11, wherein the outer contour of the collision-related part of the vehicle is ascertained based on:
a predefined geometric model of the vehicle, and/or
an image recognition method using the camera image.

16. The method according to claim 11, wherein:
the camera is a reversing camera of the vehicle, or a front camera of the vehicle, or a side camera of the vehicle, and/or
the collision-related part of the vehicle represents at least a part of a bumper of the vehicle and/or a trailer hitch of the vehicle.

17. The method according to claim 11, wherein the outer contour and/or the collision-related part of the vehicle is at least partially overlaid with a corresponding assistive graphic in the display.

18. The method according to claim 11, wherein the display of the vehicle is a central display of the vehicle and/or a display of an instrument cluster of the vehicle and/or a head-up display of the vehicle.

19. An apparatus, comprising:
a camera;
a display; and
an evaluation unit, wherein the evaluation unit is configured to execute a method for displaying maneuver-related assistive lines in the display of a vehicle, the method including the following steps:
producing a camera image using the camera arranged on the vehicle, wherein:
the camera image captures both an environment of the vehicle and a collision-related part of the vehicle, and
the collision-related part of the vehicle is a constituent part of a body of the vehicle and/or an add-on part of the vehicle, which, during a driving maneuver in a direction of a field of view of the camera, is highly likely to be first to come into contact with objects foreign to the vehicle,
ascertaining an outer contour of the collision-related part of the vehicle, wherein the outer contour of the collision-related part of the vehicle is:
a line at which the collision-related part of the body of the vehicle that is visible in the camera image adjoins a part of the camera image that represents the environment of the vehicle,
ascertained based on a predefined geometric model of the vehicle and/or based on an image recognition method using the camera image, and
displaying the camera image in the display of the vehicle, wherein the camera image is overlaid with at least one assistive line, provided for a maneuvering operation, which extends from the outer contour of the collision-related part of the vehicle into the environment of the vehicle, wherein:
the at least one assistive line is sharply cropped by the outer contour of the collision-related part such that the at least one assistive line exactly follows a course of the outer contour at a cropped edge, and
a transparency of the at least one assistive line is increased in a direction of the outer contour and/or a brightness of the at least one assistive line is reduced in a direction of the outer contour.
